(19) United States
(12) Patent Application Publication
(10) Pub. No.: US 2020/0402068 A1
(43) Pub. Date: Dec. 24, 2020

(54) Method, System, and Computer Program Product for Account Verification

(71) Applicant: Visa International Service Association, San Francisco, CA (US)

(72) Inventors: Steven David Cracknell, San Mateo, CA (US); Navendu Chandra, Danville, CA (US)

(21) Appl. No.: 16/906,037

(22) Filed: Jun. 19, 2020

Related U.S. Application Data
(60) Provisional application No. 62/864,650, filed on Jun. 21, 2019.

(51) Int. Cl. G06Q 20/42; G06Q 20/40; G06Q 20/10

(52) U.S. Cl. CPC G06Q 20/425; G06Q 20/102; G06Q 20/405; G06Q 20/4037

(57) ABSTRACT

A method, system, and computer program product for account verification that receive, from a verification system, an account verification response corresponding to an account verification request, the account verification request being associated with an account identifier, and the account identifier being associated with account data; predict, based on the account data, at least one of: (i) a probability score including a probability of a future transaction associated with the account identifier being authorized and (ii) a preferred billing date associated with a probability of the future transaction associated with the account identifier being authorized on that preferred billing date; and communicate, to a requesting system, the account verification response and the at least one of: (i) the probability score and (ii) the preferred billing date.

### CROSS REFERENCE TO RELATED APPLICATIONS

This application claims priority to U.S. Provisional Patent Application No. 62/864,650, filed on Jun. 21, 2019, the disclosure of which is incorporated by reference herein in its entirety.

### BACKGROUND

### 1. Field

This disclosure relates generally to systems, devices, products, apparatus, and methods for account verification, and in some embodiments or aspects, to a method, a system, and a product for predicting a probability of a future transaction associated with a verified account being authorized.

### 2. Technical Considerations

Service providers and recurring billers that offer free promotional periods (e.g., ecommerce service providers, such as a video streaming services, and/or the like, that provide a free trial period for the use of their service, etc.) may often receive significant numbers of declined transactions when the service providers attempt to collect a first payment from the account used to sign up for the free trial or promotional offer after the free trial period or promotional offer ends. For example, a merchant system is typically limited or restricted to using a $0 or null amount account verification process, which only indicates whether the account is active and in good standing (e.g., only indicates that a payment device exists and an account identifier is valid or active without confirming an account balance and/or an ability of the account or payment device to be used for payment of a request for a particular transaction amount, etc.), when enrolling a consumer in a promotional offer or for a free trial service period associated with the account. As an example, an account verification response that verifies the account may not provide insight into or information on whether the payment device is likely to be approved for a first or future transaction after the promotional offer or free trial service period ends (e.g. a first charge for a first month of a video streaming service after expiration of the free trial period for the service, etc.). In such an example, a merchant system may receive a declined transaction authorization response when the merchant system attempts to process the first or future transaction using the account provided to sign up for the promotional offer or the free trial period. For example, the consumer may have provided a prepaid card that may have no balance at the time of payment processing for an amount of the first or future transaction after the promotional offer or free trial period expires. Further, many merchant systems typically use a uniform (and often blunt) retry strategy for declined transaction authorization requests that results in excessive declines on a subset of cards which negatively impacts an overall approval rate for the merchant system and/or results in higher processing costs for the merchant system. Accordingly, there is a need for improved account verification.

### SUMMARY

Accordingly, provided are improved systems, devices, products, apparatus, and/or methods for account verification.

According to some non-limiting embodiments or aspects, provided is a computer-implemented method, including: receiving, with at least one processor from a verification system, an account verification response corresponding to an account verification request, wherein the account verification request is associated with an account identifier, and wherein the account identifier is associated with account data; predicting, with at least one processor, based on the account data, at least one of: (i) a probability score including a probability of a future transaction associated with the account identifier being authorized and (ii) a preferred billing date associated with a probability of the future transaction associated with the account identifier being authorized on that preferred billing date; and communicating, with at least one processor to a requesting system, the account verification response and the at least one of: the probability score and (ii) the preferred billing date.

In some non-limiting embodiments or aspects, the method further includes: receiving, with at least one processor from the requesting system, the account verification request; and communicating, with at least one processor to the verification system, the account verification request.

In some non-limiting embodiments or aspects, the method further includes: receiving, with at least one processor from the requesting system, an amount associated with the future transaction and a time associated with the future transaction, wherein predicting the at least one of: (i) the probability score and (ii) the preferred billing date is further based on the amount associated with the future transaction and the time associated with the future transaction.

In some non-limiting embodiments or aspects, the account data is associated with at least one of: a type of a payment device associated with the account identifier, a reloadability associated with the payment device, a transaction history associated with the account identifier, an amount of recurring billing associated with the account identifier, an approval rate associated with the account identifier, an amount of time associated with the account identifier being active, an expiration date of the payment device, or any combination thereof.

In some non-limiting embodiments or aspects, the account verification request does not include a transaction amount.

In some non-limiting embodiments or aspects, the future transaction includes a recurring transaction.

In some non-limiting embodiments or aspects, the verification system includes an issuer system, and the requesting system includes at least one of a merchant system and an acquirer system.

According to some non-limiting embodiments or aspects, provided is a computing system including: one or more processors programmed and/or configured to: receive, from a verification system, an account verification response corresponding to an account verification request, wherein the account verification request is associated with an account identifier, and wherein the account identifier is associated with account data; predict, based on the account data, at least one of: (i) a probability score including a probability of a future transaction associated with the account identifier being authorized and (ii) a preferred billing date associated with a probability of the future transaction associated with the account identifier being authorized on that preferred billing date; and communicate, to a requesting system, the account verification response and the at least one of: (i) the probability score and (ii) the preferred billing date.

In some non-limiting embodiments or aspects, the one or more processors are further programmed and/or configured to: receive, from the requesting system, the account verification request; and communicate, to the verification system, the account verification request.

In some non-limiting embodiments or aspects, the one or more processors are further programmed and/or configured to: receive, from the requesting system, an amount associated with the future transaction and a time associated with the future transaction, wherein the at least one of: (i) the probability score and (ii) the preferred billing date is further predicted based on the amount associated with the future transaction and the time associated with the future transaction.

In some non-limiting embodiments or aspects, the account data is associated with at least one of: a type of a payment device associated with the account identifier, a reloadability associated with the payment device, a transaction history associated with the account identifier, an amount of recurring billing associated with the account identifier, an approval rate associated with the account identifier, an amount of time associated with the account identifier being active, an expiration date of the payment device, or any combination thereof.

In some non-limiting embodiments or aspects, the account verification request does not include a transaction amount.

In some non-limiting embodiments or aspects, the future transaction includes a recurring transaction.

In some non-limiting embodiments or aspects, the verification system includes an issuer system, and the requesting system includes at least one of a merchant system and an acquirer system.

According to some non-limiting embodiments or aspects, provided is a computer program product including at least one non-transitory computer-readable medium including program instructions that, when executed by at least one processor, cause the at least one processor to: receive, from a verification system, an account verification response corresponding to an account verification request, wherein the account verification request is associated with an account identifier, and wherein the account identifier is associated with account data; predict, based on the account data, at least one of: (i) a probability score including a probability of a future transaction associated with the account identifier being authorized and (ii) a preferred billing date associated with a probability of the future transaction associated with the account identifier being authorized on that preferred billing date; and communicate, to a requesting system, the account verification response and the at least one of: (i) the probability score and (ii) the preferred billing date.

In some non-limiting embodiments or aspects, the instructions further cause the at least one processor to: receive, from the requesting system, the account verification request; and communicate, to the verification system, the account verification request.

In some non-limiting embodiments or aspects, the instructions further cause the at least one processor to: receive, from the requesting system, an amount associated with the future transaction and a time associated with the future transaction, wherein the at least one of: (i) the probability score and (ii) the preferred billing date is further predicted based on the amount associated with the future transaction and the time associated with the future transaction.

In some non-limiting embodiments or aspects, the account data is associated with at least one of: a type of a payment device associated with the account identifier, a reloadability associated with the payment device, a transaction history associated with the account identifier, an amount of recurring billing associated with the account identifier, an approval rate associated with the account identifier, an amount of time associated with the account identifier being active, an expiration date of the payment device, or any combination thereof.

In some non-limiting embodiments or aspects, the account verification request does not include a transaction amount, and the future transaction includes a recurring transaction.

In some non-limiting embodiments or aspects, the verification system includes an issuer system, and the requesting system includes at least one of a merchant system and an acquirer system.

Further embodiments or aspects are set forth in the following numbered clauses:

Clause 1. A computer-implemented method comprising: receiving, with at least one processor from a verification system, an account verification response corresponding to an account verification request, wherein the account verification request is associated with an account identifier, and wherein the account identifier is associated with account data; predicting, with at least one processor, based on the account data, at least one of (i) a probability score including a probability of a future transaction associated with the account identifier being authorized and (ii) a preferred billing date associated with a probability of the future transaction associated with the account identifier being authorized on that preferred billing date; and communicating, with at least one processor to a requesting system, the account verification response and the at least one of: (i) the probability score and (ii) the preferred billing date.

Clause 2. The computer-implemented method of clause 1, further comprising: receiving, with at least one processor from the requesting system, the account verification request; and communicating, with at least one processor to the verification system, the account verification request.

Clause 3. The computer-implemented method of clauses 1 or 2, further comprising: receiving, with at least one processor from the requesting system, an amount associated with the future transaction and a time associated with the future transaction, wherein predicting the at least one of: (i) the probability score and (ii) the preferred billing date is further based on the amount associated with the future transaction and the time associated with the future transaction.

Clause 4. The computer-implemented method of any of clauses 1-3, wherein the account data is associated with at least one of: a type of a payment device associated with the account identifier, a reloadability associated with the payment device, a transaction history associated with the account identifier, an amount of recurring billing associated with the account identifier, an approval rate associated with the account identifier, an amount of time associated with the account identifier being active, an expiration date of the payment device, or any combination thereof.

Clause 5. The computer-implemented method of any of clauses 1-4, wherein the account verification request does not include a transaction amount.

Clause 6. The computer-implemented method of any of clauses 1-5, wherein the future transaction includes a recurring transaction.

Clause 7. The computer-implemented method of any of clauses 1-6, wherein the verification system includes an issuer system, and wherein the requesting system includes at least one of a merchant system and an acquirer system.

Clause 8. A computing system comprising: one or more processors programmed and/or configured to: receive, from a verification system, an account verification response corresponding to an account verification request, wherein the account verification request is associated with an account identifier, and wherein the account identifier is associated with account data; predict, based on the account data, at least one of: (i) a probability score including a probability of a future transaction associated with the account identifier being authorized and (ii) a preferred billing date associated with a probability of the future transaction associated with the account identifier being authorized on that preferred billing date; and communicate, to a requesting system, the account verification response and the at least one of: (i) the probability score and (ii) the preferred billing date.

Clause 9. The computing system of clause 8, wherein the one or more processors are further programmed and/or configured to: receive, from the requesting system, the account verification request; and communicate, to the verification system, the account verification request.

Clause 10. The computing system of clauses 8 or 9, wherein the one or more processors are further programmed and/or configured to: receive, from the requesting system, an amount associated with the future transaction and a time associated with the future transaction, wherein the at least one of: (i) the probability score and (ii) the preferred billing date is further predicted based on the amount associated with the future transaction and the time associated with the future transaction.

Clause 11. The computing system of any of clauses 8-10, wherein the account data is associated with at least one of: a type of a payment device associated with the account identifier, a reloadability associated with the payment device, a transaction history associated with the account identifier, an amount of recurring billing associated with the account identifier, an approval rate associated with the account identifier, an amount of time associated with the account identifier being active, an expiration date of the payment device, or any combination thereof.

Clause 12. The computing system of any of clauses 8-11, wherein the account verification request does not include a transaction amount.

Clause 13. The computing system of any of clauses 8-12, wherein the future transaction includes a recurring transaction.

Clause 14. The computing system of any of clauses 8-13, wherein the verification system includes an issuer system, and wherein the requesting system includes at least one of a merchant system and an acquirer system.

Clause 15. A computer program product comprising at least one non-transitory computer-readable medium including program instructions that, when executed by at least one processor, cause the at least one processor to: receive, from a verification system, an account verification response corresponding to an account verification request, wherein the account verification request is associated with an account identifier, and wherein the account identifier is associated with account data; predict, based on the account data, at least one of: (i) a probability score including a probability of a future transaction associated with the account identifier being authorized and (ii) a preferred billing date associated with a probability of the future transaction associated with the account identifier being authorized on that preferred billing date; and communicate, to a requesting system, the account verification response and the at least one of: (i) the probability score and (ii) the preferred billing date.

Clause 16. The computer program product of clause 15, wherein the instructions further cause the at least one processor to: receive, from the requesting system, the account verification request; and communicate, to the verification system, the account verification request.

Clause 17. The computer program product of clauses 15 or 16, wherein the instructions further cause the at least one processor to: receive, from the requesting system, an amount associated with the future transaction and a time associated with the future transaction, wherein the at least one of: (i) the probability score and (ii) the preferred billing date is further predicted based on the amount associated with the future transaction and the time associated with the future transaction.

Clause 18. The computer program product of any of clauses 15-17, wherein the account data is associated with at least one of: a type of a payment device associated with the account identifier, a reloadability associated with the payment device, a transaction history associated with the account identifier, an amount of recurring billing associated with the account identifier, an approval rate associated with the account identifier, an amount of time associated with the account identifier being active, an expiration date of the payment device, or any combination thereof.

Clause 19. The computer program product of any of clauses 15-18, wherein the account verification request does not include a transaction amount, and wherein the future transaction includes a recurring transaction.

Clause 20. The computer program product of any of clauses 15-19, wherein the verification system includes an issuer system, and wherein the requesting system includes at least one of a merchant system and an acquirer system.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of limits. As used in the specification and the claims, the singular form of “a,” “an,” and “the” include plural referents unless the context clearly dictates otherwise.

### BRIEF DESCRIPTION OF THE DRAWINGS

Additional advantages and details are explained in greater detail below with reference to the exemplary embodiments or aspects that are illustrated in the accompanying schematic figures, in which:

FIG. 1 is a diagram of non-limiting embodiments or aspects of an environment in which systems, devices, products, apparatus, and/or methods, described herein, may be implemented;

FIG. 2 is a diagram of non-limiting embodiments or aspects of components of one or more devices and/or one or more systems of FIG. 1;

FIG. 3 is a flowchart of non-limiting embodiments or aspects of a process for account verification; and

FIG. 4 is a signal flow diagram of an implementation of non-limiting embodiments or aspects of a process for account verification.

### DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

It will be apparent that systems and/or methods, described herein, can be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

As used herein, the term “transaction service provider” may refer to an entity that receives transaction authorization requests from merchants or other entities and provides guarantees of payment, in some cases through an agreement between the transaction service provider and an issuer institution. The terms “transaction service provider” and “transaction service provider system” may also refer to one or more computer systems operated by or on behalf of a transaction service provider, such as a transaction processing system executing one or more software applications. A transaction processing system may include one or more server computers with one or more processors and, in some non-limiting embodiments or aspects, may be operated by or on behalf of a transaction service provider.

As used herein, the term “account identifier” may include one or more Primary Account Numbers (PAN), tokens, or other identifiers (e.g., a globally unique identifier (GUID), a universally unique identifier (UUID), etc.) associated with a customer account of a user (e.g., a customer, a consumer, and/or the like). The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more databases such that they can be used to conduct a transaction without directly using the original account identifier. In some examples, an original account identifier, such as a PAN, may be associated with a plurality of tokens for different individuals or purposes.

As used herein, the terms “issuer institution,” “portable financial device issuer,” “issuer,” or “issuer bank” may refer to one or more entities that provide one or more accounts to a user (e.g., a customer, a consumer, an entity, an organization, and/or the like) for conducting transactions (e.g., payment transactions), such as initiating credit card payment transactions and/or debit card payment transactions. For example, an issuer institution may provide an account identifier, such as a personal account number (PAN), to a user that uniquely identifies one or more accounts associated with that user. The account identifier may be embodied on a portable financial device, such as a physical financial instrument (e.g., a payment card), and/or may be electronic and used for electronic payments. In some non-limiting embodiments or aspects, an issuer institution may be associated with a bank identification number (BIN) that uniquely identifies the issuer institution. As used herein “issuer institution system” may refer to one or more computer systems operated by or on behalf of an issuer institution, such as a server computer executing one or more software applications. For example, an issuer institution system may include one or more authorization servers for authorizing a payment transaction.

As used herein, the term “merchant” may refer to an individual or entity that provides products and/or services, or access to products and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices. The terms “client device” and “user device,” as used herein, refer to any electronic device that is configured to communicate with one or more servers or remote devices and/or systems. A client device or user device may include a mobile device, a network-enabled appliance (e.g., a network-enabled television, refrigerator, thermostat, and/or the like), a computer, a POS system, and/or any other device or system capable of communicating with a network.

As used herein, the term “computing device” or “computer device” may refer to one or more electronic devices that are configured to directly or indirectly communicate with or over one or more networks. The computing device may be a mobile device, a desktop computer, or the like. Furthermore, the term “computer” may refer to any computing device that includes the necessary components to receive, process, and output data, and normally includes a display, a processor, a memory, an input device, and a network interface. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.).

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Wallet™, Android Pay®, Apple Pay®, Samsung Pay®, and/or other like electronic payment systems. In some non-limiting examples, an issuer bank may be an electronic wallet provider.

As used herein, the term “portable financial device” or “payment device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a mobile device executing an electronic wallet application, a personal digital assistant (PDA), a security card, an access card, a wireless terminal, and/or a transponder, as examples. The portable financial device may include a volatile or a non-volatile memory to store information, such as an account identifier and/or a name of the account holder.

As used herein, the term “server” may refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, such as POS devices, directly or indirectly communicating in the network environment may constitute a “system,” such as a merchant's POS system.

As used herein, the term “acquirer” may refer to an entity licensed by the transaction service provider and/or approved by the transaction service provider to originate transactions using a portable financial device of the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

Provided are improved systems, devices, products, apparatus, and/or methods for account verification.

As previously discussed, existing account verification systems have no mechanism for determining and/or providing insight into or information on whether a payment device and/or an account identifier is likely to be approved for a first or future transaction after the payment device and/or the account identifier is verified (e.g., after a promotional offer or a free trial service period for which the payment device and/or account identified is used for enrollment ends, etc.). In this way, merchants may have no way of knowing whether future transactions are likely to be approved for enrolled or verified account identifiers.

Non-limiting embodiments or aspects of the present disclosure are directed to systems, methods, and computer program products for account verification that receive, from a verification system, an account verification response corresponding to an account verification request, the account verification request being associated with an account identifier, and the account identifier being associated with account data; predict, based on the account data, at least one of: (i) a probability score including a probability of a future transaction associated with the account identifier being authorized and (ii) a preferred billing date associated with a probability of the future transaction associated with the account identifier being authorized on that preferred billing date; and communicate, to a requesting system, the account verification response and the at least one of: (i) the probability score and (ii) the preferred billing date. In this way, by modifying an account verification response to include the probability score and/or the preferred billing date, merchant systems can be provided with a probability associated with whether future transactions are likely to be approved for enrolled or verified account identifiers and/or a preferred billing date on which future transactions are more likely to be approved for enrolled or verified account identifiers. Accordingly, merchant systems may adjust a promotional offer (e.g., offer terms, offer length, payment amount, payment date, etc.) to a consumer associated with the account identifier and/or request or require a different account identifier and/or payment device be used in order for the consumer to receive the promotional offer to decrease a risk associated with future transactions being declined and/or increase a probability of the future transactions being approved, and/or merchant systems may time or schedule authorization retries following declined transactions to improve probabilities of the retries being approved, which may result in a better overall approval rate for the merchants and/or lower processing costs for the merchants.

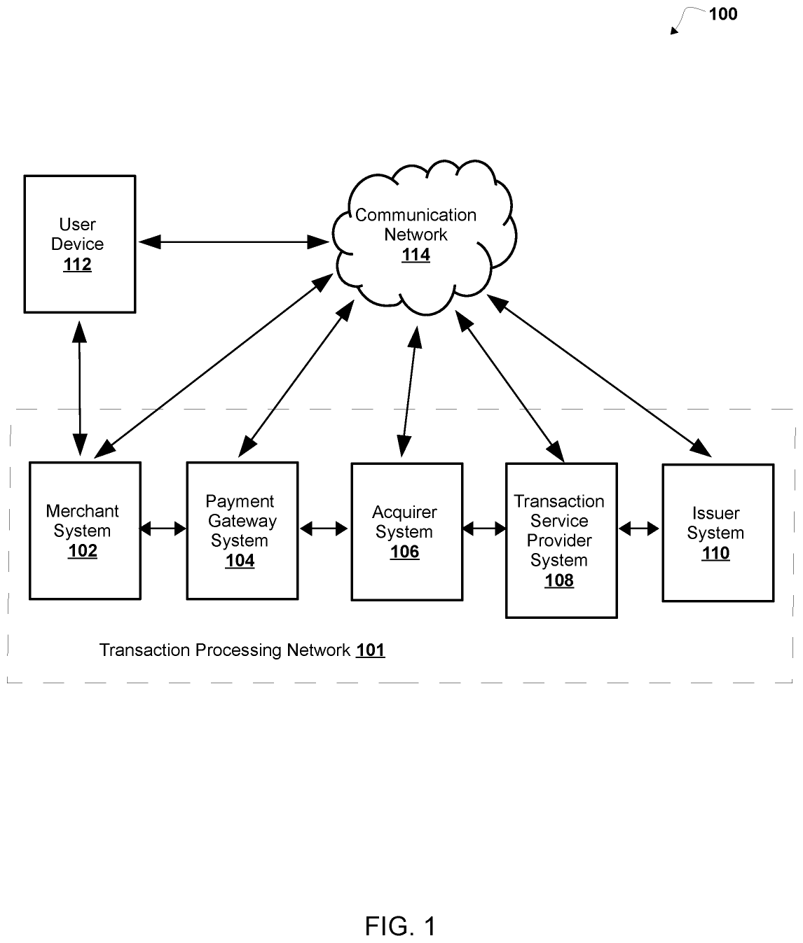

Referring now to FIG. 1, FIG. 1 is a diagram of an example environment 100 in which devices, systems, methods, and/or products described herein, may be implemented. As shown in FIG. 1, environment 100 includes transaction processing network 101, which may include merchant system 102, payment gateway system 104, acquirer system 106, transaction service provider system 108, and/or issuer system 110, user device 112, and/or communication network 114. Transaction processing network 101, merchant system 102, payment gateway system 104, acquirer system 106, transaction service provider system 108, issuer system 110, and/or user device 112 may interconnect (e.g., establish a connection to communicate, etc.) via wired connections, wireless connections, or a combination of wired and wireless connections.

Merchant system 102 may include one or more devices capable of receiving information and/or data from payment gateway system 104, acquirer system 106, transaction service provider system 108, issuer system 110, and/or user device 112 (e.g., via communication network 114, etc.) and/or communicating information and/or data to payment gateway system 104, acquirer system 106, transaction service provider system 108, issuer system 110, and/or user device 112 (e.g., via communication network 114, etc.). Merchant system 102 may include a device capable of receiving information and/or data from user device 112 via a communication connection (e.g., an NFC communication connection, an RFID communication connection, a Bluetooth® communication connection, etc.) with user device 112, and/or communicating information and/or data to user device 112 via the communication connection. For example, merchant system 102 may include a computing device, such as a server, a group of servers, a client device, a group of client devices, and/or other like devices. In some non-limiting embodiments or aspects, merchant system 102 may be associated with a merchant as described herein. In some non-limiting embodiments or aspects, merchant system 102 may include one or more devices, such as computers, computer systems, and/or peripheral devices capable of being used by a merchant to conduct a payment transaction with a user. For example, merchant system 102 may include a POS device and/or a POS system. In some non-limiting embodiments or aspects, a requesting system that generates and/or transmits an account verification request may include merchant system 102.

Payment gateway system 104 may include one or more devices capable of receiving information and/or data from merchant system 102, acquirer system 106, transaction service provider system 108, issuer system 110, and/or user device 112 (e.g., via communication network 114, etc.) and/or communicating information and/or data to merchant system 102, acquirer system 106, transaction service provider system 108, issuer system 110, and/or user device 112 (e.g., via communication network 114, etc.). For example, payment gateway system 104 may include a computing device, such as a server, a group of servers, and/or other like devices. In some non-limiting embodiments or aspects, payment gateway system 104 is associated with a payment gateway as described herein. In some non-limiting embodiments or aspects, a requesting system that generates and/or transmits an account verification request may include payment gateway system 104.

Acquirer system 106 may include one or more devices capable of receiving information and/or data from merchant system 102, payment gateway system 104, transaction service provider system 108, issuer system 110, and/or user device 112 (e.g., via communication network 114, etc.) and/or communicating information and/or data to merchant system 102, payment gateway system 104, transaction service provider system 108, issuer system 110, and/or user device 112 (e.g., via communication network 114, etc.). For example, acquirer system 106 may include a computing device, such as a server, a group of servers, and/or other like devices. In some non-limiting embodiments or aspects, acquirer system 106 may be associated with an acquirer as described herein. In some non-limiting embodiments or aspects, a requesting system that generates and/or transmits an account verification request may include acquirer system 106.

Transaction service provider system 108 may include one or more devices capable of receiving information and/or data from merchant system 102, payment gateway system 104, acquirer system 106, issuer system 110, and/or user device 112 (e.g., via communication network 114, etc.) and/or communicating information and/or data to merchant system 102, payment gateway system 104, acquirer system 106, issuer system 110, and/or user device 112 (e.g., via communication network 114, etc.). For example, transaction service provider system 108 may include a computing device, such as a server (e.g., a transaction processing server, etc.), a group of servers, and/or other like devices. In some non-limiting embodiments or aspects, transaction service provider system 108 may be associated with a transaction service provider as described herein. In some non-limiting embodiments or aspects, transaction service provider 108 may include and/or access one or more one or more internal and/or external databases including account data, transaction data, merchant data, account verification request data, account verification response data, and/or the like.

Issuer system 110 may include one or more devices capable of receiving information and/or data from merchant system 102, payment gateway system 104, acquirer system 106, transaction service provider system 108, and/or user device 112 (e.g., via communication network 114, etc.) and/or communicating information and/or data to merchant system 102, payment gateway system 104, acquirer system 106, transaction service provider system 108, and/or user device 112 (e.g., via communication network 114, etc.). For example, issuer system 110 may include a computing device, such as a server, a group of servers, and/or other like devices. In some non-limiting embodiments or aspects, issuer system 110 may be associated with an issuer institution as described herein. For example, issuer system 110 may be associated with an issuer institution that issued a payment account or instrument (e.g., a credit account, a debit account, a credit card, a debit card, etc.) to a user (e.g., a user associated with user device 112, etc.). In some non-limiting embodiments or aspects, a verification system that verifies an account identifier in response to an account verification request and/or transmits an account verification response associated therewith may include issuer system 110.

In some non-limiting embodiments or aspects, transaction processing network 101 includes a plurality of systems in a communication path for processing a transaction. For example, transaction processing network 101 may include merchant system 102, payment gateway system 104, acquirer system 106, transaction service provider system 108, and/or issuer system 110 in a communication path (e.g., a communication path, a communication channel, a communication network, etc.) for processing an electronic payment transaction. As an example, transaction processing network 101 may process (e.g., initiate, conduct, authorize, etc.) an electronic payment transaction via the communication path between merchant system 102, payment gateway system 104, acquirer system 106, transaction service provider system 108, and/or issuer system 110.

User device 112 may include one or more devices capable of receiving information and/or data from merchant system 102, payment gateway system 104, acquirer system 106, transaction service provider system 108, and/or issuer system 110 (e.g., via communication network 114, etc.) and/or communicating information and/or data to merchant system 102, payment gateway system 104, acquirer system 106, transaction service provider system 108, and/or issuer system 110 (e.g., via communication network 114, etc.). For example, user device 112 may include a client device and/or the like. In some non-limiting embodiments or aspects, user device 112 may be capable of receiving information (e.g., from merchant system 102, etc.) via a short range wireless communication connection (e.g., an NFC communication connection, an RFID communication connection, a Bluetooth® communication connection, and/or the like), and/or communicating information (e.g., to merchant system 102, etc.) via a short range wireless communication connection. In some non-limiting embodiments or aspects, user device 112 may include an application associated with user device 112, such as an application stored on user device 112, a mobile application (e.g., a mobile device application, a native application for a mobile device, a mobile cloud application for a mobile device, an electronic wallet application, a peer-to-peer payment transfer application, and/or the like) stored and/or executed on user device 112.

Communication network 114 may include one or more wired and/or wireless networks. For example, communication network 114 may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and systems shown in FIG. 1 is provided as an example. There may be additional devices and/or systems, fewer devices and/or systems, different devices and/or systems, or differently arranged devices and/or systems than those shown in FIG. 1. Furthermore, two or more devices and/or systems shown in FIG. 1 may be implemented within a single device and/or system, or a single device and/or system shown in FIG. 1 may be implemented as multiple, distributed devices and/or systems. Additionally, or alternatively, a set of devices and/or systems (e.g., one or more devices or systems) of environment 100 may perform one or more functions described as being performed by another set of devices or systems of environment 100.

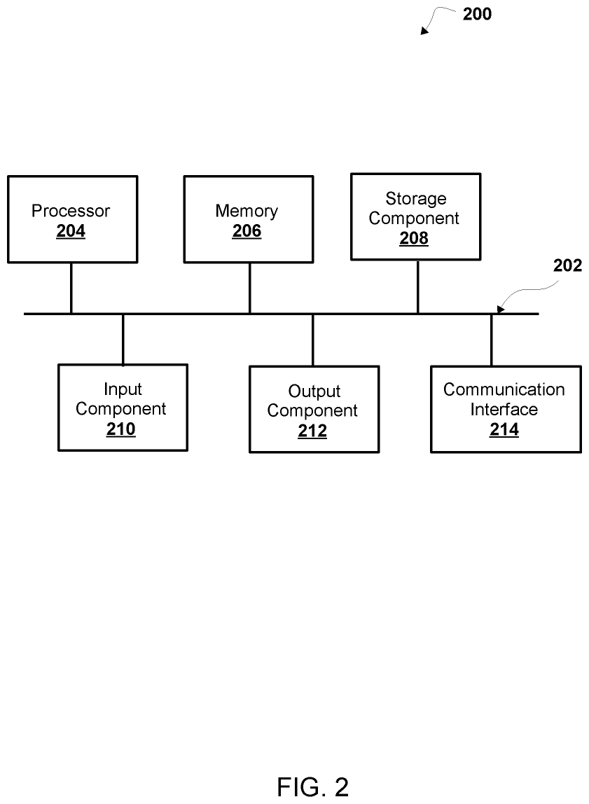

Referring now to FIG. 2, FIG. 2 is a diagram of example components of a device 200. Device 200 may correspond to one or more devices of transaction processing network 101, one or more devices of merchant system 102, one or more devices of payment gateway system 104, one or more devices of acquirer system 106, one or more devices of transaction service provider system 108, one or more devices of issuer system 110, user device 112 (e.g., one or more devices of a system of user device 112, etc.), and/or one or more devices of communication network 114. In some non-limiting embodiments or aspects, one or more devices of transaction processing network 101, one or more devices of merchant system 102, one or more devices of payment gateway system 104, one or more devices of acquirer system 106, one or more devices of transaction service provider system 108, one or more devices of issuer system 110, user device 112 (e.g., one or more devices of a system of user device 112, etc.), and/or one or more devices of communication network 114 may include at least one device 200 and/or at least one component of device 200. As shown in FIG. 2, device 200 may include a bus 202, a processor 204, memory 206, a storage component 208, an input component 210, an output component 212, and a communication interface 214.

Bus 202 may include a component that permits communication among the components of device 200. In some non-limiting embodiments or aspects, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments or aspects described herein are not limited to any specific combination of hardware circuitry and software.

Memory 206 and/or storage component 208 may include data storage or one or more data structures (e.g., a database, etc.). Device 200 may be capable of receiving information from, storing information in, communicating information to, or searching information stored in the data storage or one or more data structures in memory 206 and/or storage component 208. For example, transaction service provider system 108 may include and/or access one or more internal and/or external databases that store transaction data associated with transactions processed and/or being processed in transaction processing network 101 (e.g., prior or historical transactions processed via transaction service provider system 108, etc.), account data, request data, and/or the like.

The number and arrangement of components shown in FIG. 2 are provided as an example. In some non-limiting embodiments or aspects, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

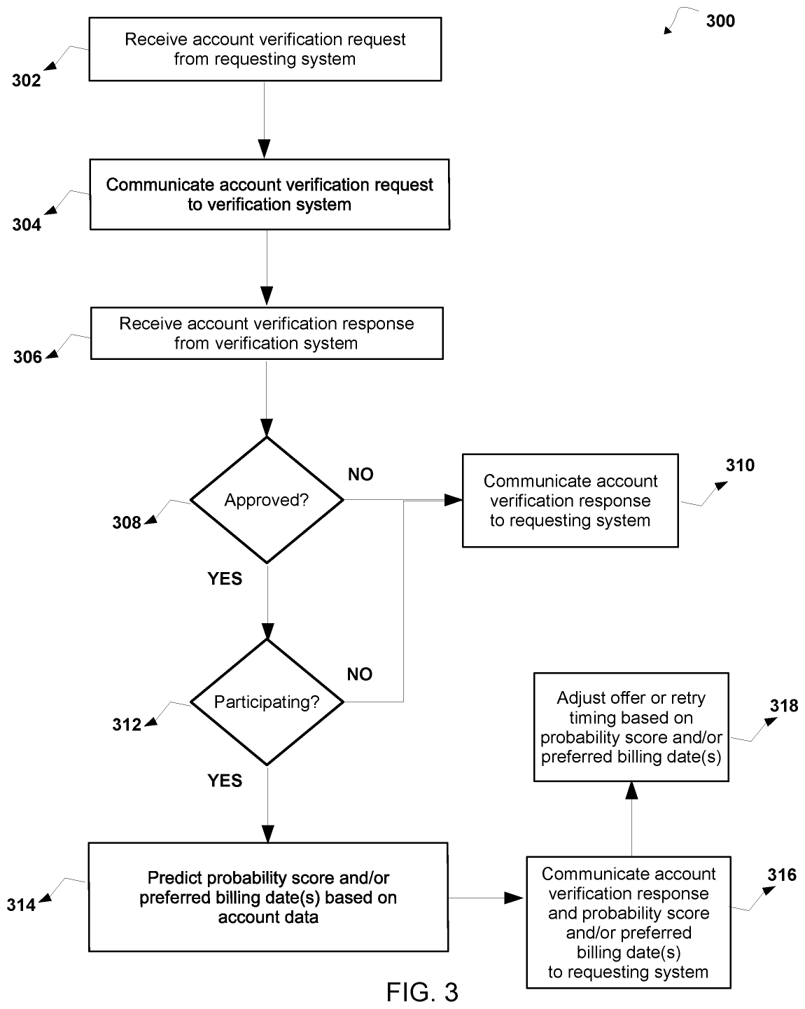

Referring now to FIG. 3, FIG. 3 is a flowchart of non-limiting embodiments or aspects of a process 300 for account verification. In some non-limiting embodiments or aspects, one or more of the steps of process 300 may be performed (e.g., completely, partially, etc.) by transaction service provider system 108 (e.g., one or more devices of transaction service provider system 108). In some non-limiting embodiments or aspects, one or more of the steps of process 300 may be performed (e.g., completely, partially, etc.) by another device or a group of devices separate from or including transaction service provider system 108, such as merchant system 102 (e.g., one or more devices of merchant system 102), payment gateway system 104 (e.g., one or more devices of payment gateway system 104), acquirer system 106 (e.g., one or more devices of acquirer system 106), issuer system 110 (e.g., one or more devices of issuer system 110), and/or user device 112 (e.g., one or more devices of a system of user device 112).

As shown in FIG. 3, at step 302, process 300 includes receiving an account verification request from a requesting system. For example, transaction service provider system 108 may receive an account verification request from a requesting system (e.g., from merchant system 102, payment gateway system 104, acquirer system 106, an ecommerce service provider, etc.). As an example, transaction service provider system 108 may receive an account verification request submitted by merchant system 102, payment gateway system 104, and/or acquirer system 106 (e.g., a recurring ecommerce merchant or acquirer, etc.) to transaction service provider system 108 to verify whether an account and/or a payment device associated with an account identifier included in the request is active and in good standing.

In some non-limiting embodiments or aspects, an account verification request is associated with an account identifier. In some-limiting embodiments or aspects, an account verification request does not include a transaction amount (e.g., a transaction amount associated with a current transaction, a transaction amount associated with the account verification process, etc.). For example, an account verification request may be used for a $0 or null amount account verification process, which only indicates whether the account is active and in good standing (e.g., consists of only an indication that a payment device exists and/or an account identifier is valid or active without confirming or providing an indication associated with an account balance and/or an ability of the account or payment device to be used for payment of a request for a particular transaction amount, etc.). As an example, an account verification request may include a 0100 account verification request submitted by merchant system 102, payment gateway system 104, and/or acquirer system 106 (e.g., a recurring ecommerce merchant or acquirer, etc.) to transaction service provider system 108.

In some non-limiting embodiments or aspects, transaction service provider system 108 may receive, from a requesting system (e.g., from merchant system 102, payment gateway system 104, acquirer system 106, an ecommerce service provider, etc.), an amount associated with a future transaction and a time associated with the future transaction. For example, an account verification request may include an amount associated with a future transaction and/or a time associated with the future transaction, such as a transaction to be initiated subsequent to the account verification process (e.g., a recurring transaction, etc.), and/or the like.

In some non-limiting embodiments or aspects, an account identifier is associated with account data. For example, account data may include the account identifier, an account verification request associated with the account identifier, an account verification response corresponding to the account verification request associated with the account identifier, a type of a payment device associated with the account identifier (e.g., a prepaid card, a debit card, a credit card, etc.), a reloadability associated with the payment device (e.g., an indication of whether a card, such as a prepaid card, can be reloaded with additional funds, etc.), a transaction history associated with the account identifier (e.g., a number of transactions, a value of the transactions, a frequency of use of the payment device, etc.), an amount of recurring billing associated with the account identifier (e.g., a number billers or service providers for which the account identifier is used for recurring payments, etc.), a transaction approval (and/or decline) rate associated with the account identifier, an amount of time associated with the account identifier being active, an expiration date of the payment device, transaction data, or any combination thereof. In some non-limiting embodiments or aspects, transaction data may include parameters associated with a transaction, such as an account identifier (e.g., a PAN, etc.), a transaction amount, a transaction date and time, a type of products and/or services associated with the transaction, a conversion rate of currency, a type of currency, a merchant type, a merchant name, a merchant location, a transaction approval (and/or decline) rate, and/or the like.

As shown in FIG. 3, at step 304, process 300 includes communicating an account verification request to a verification system. For example, transaction service provider system 108 may communicate an account verification request to a verification system (e.g., issuer system 110, etc.). As an example, transaction service provider system 108 may communicate the account verification request to the verification system. In such an example, transaction service provider system 108 may route the account verification request (e.g., the 0100 account verification request, etc.) to issuer system 110 in transaction process network 101.

As shown in FIG. 3, at step 306, process 300 includes receiving an account verification response from a verification system. For example, transaction service provider system 108 may receive, from a verification system, an account verification response corresponding to an account verification request. As an example, transaction service provider system 108 may receive, from the verification system (e.g., from issuer system 110, etc.), an account verification response corresponding to the account verification request.

In some non-limiting embodiments or aspects, an account verification response includes an approval or a denial of an account verification request associated with an account identifier. In some-limiting embodiments or aspects, an account verification response does not include a transaction amount (e.g., a transaction amount associated with a current transaction, a transaction amount associated with the account verification process, etc.). For example, an account verification response may be associated with a $0 or null amount account verification process. As an example, an account verification response may only indicate whether the account is active and in good standing (e.g., may consist of only an indication that a payment device exists and/or an account identifier is valid or active without confirming or providing an indication associated with an account balance and/or an ability of the account or payment device to be used for payment of a request for a particular transaction amount, etc.). In such an example, an account verification response may include a 0110 account verification response generated by issuer system 110 based on the account identifier (e.g., using a look-up table, a whitelist, a blacklist, a prediction model, a business rules module, etc.) associated with the account verification request, and issuer system 110 may route the account verification response to transaction service provider system 108 in transaction processing network 101.

As shown in FIG. 3, at step 308, process 300 includes determining whether the account verification response is associated with an approval or a denial of the account verification request. For example, transaction service provider system 108 may determine whether the account verification response is associated with an approval or a denial of the account verification request. As an example, transaction service provider system 108 may identify an approval or a denial of an account verification request associated with an account identifier that is included in the account verification response (e.g., a response code, etc.).

As shown in FIG. 3, if at step 308, process 300 determines that the account verification response is associated with a denial of the account verification request, at step 310, process 300 includes communicating an account verification response to a requesting system. For example, transaction service provider system 108 communicates the account verification response to the requesting system. As an example, transaction service provider system 108 communicates the account verification response to the requesting system (e.g., to merchant system 102, payment gateway system 104, acquirer system 106, an ecommerce service provider, etc.) without modifying and/or adding any additional data to the account verification response (e.g., without a probability score as described herein, without a preferred billing date(s) as described herein, etc.).

As shown in FIG. 3, if at step 308, process 300 determines that the account verification response is associated with an approval of the account verification request, at step 312, process 300 includes determining whether the requesting system associated with the account verification request participates in (e.g., is enrolled in, etc.) an intelligent account verification process. For example, transaction service provider system 108 may determine whether the requesting system (e.g., merchant system 102, payment gateway system 104, acquirer system 106, an ecommerce service provider, etc.) associated with the account verification request participates in an intelligent account verification process. As an example, transaction service provider system 108 may identify the requesting system as participating in the intelligent account verification process using a look-up table and an identifier associated with the requesting system (e.g., a unique identifier, a merchant identifier, an address, etc.). In some non-limiting embodiments or aspects, a requesting system may modify an account verification request to include a flag or other indicator that indicates the requesting system associated with the account verification request participates in the intelligent account verification system, and transaction service provider system 108 may identify the flag included in the account verification request to determine that the requesting system participates in the intelligent account verification process.

As shown in FIG. 3, if at step 312, process 300 determines that the requesting system does not participate in the intelligent account verification process, at step 310, process 300 includes communicating an account verification response to a requesting system. For example, transaction service provider system 108 communicates the account verification response to the requesting system. As an example, transaction service provider system 108 communicates the account verification response to the requesting system (e.g., to merchant system 102, payment gateway system 104, acquirer system 106, an ecommerce service provider, etc.) without modifying and/or adding any additional data to the account verification response (e.g., without a probability score as described herein, etc.).

As shown in FIG. 3, if at step 312, process 300 determines that the requesting system participates in the intelligent account verification process, at step 314, process 300 includes predicting a probability score and/or a preferred billing date(s) based on account data. For example, transaction service provider system 108 predicts a probability score and/or a preferred billing date(s) based on account data. As an example, transaction service provider system 108 predicts, based on the account data, a probability score including a probability of a future transaction associated with the account identifier being authorized and/or a preferred billing date(s) associated with a probability of a future transaction associated with the account identifier being authorized on that preferred billing date (e.g., a preferred billing date(s) associated with a probability of a future transaction associated with the account identifier being authorized on that preferred billing date above a threshold probability, an optimal billing date associated with an optimal or highest probability of a range of probabilities of approval for a range of future dates of a future transaction associated with the account identifier being authorized on that optimal billing date, a future date(s) on which the future transaction is more or most likely to be authorized, etc.). In such an example, the future transaction may be a transaction initiated and/or executed subsequent to the account verification process (e.g., subsequent to communicating an account verification response to a requesting system in response to an account verification request received from that requesting system, etc.).

In some non-limiting embodiments, the future transaction may include a recurring transaction. For example, the future transaction may be a first transaction associated with the account identifier and the requesting system that is initiated or executed after expiration of a time period for a promotional offer or a free trial period offered by the requesting system.

In some non-limiting embodiments or aspects, predicting the probability score and/or the preferred billing date is further based on the amount associated with the future transaction and/or the time associated with the future transaction. For example, transaction service provider system 108 may predict the probability score and/or the preferred billing date based on the account data and/or the amount associated with the future transaction and/or the time associated with the future transaction. In some non-limiting embodiments or aspects, the account data may include or be associated with the amount of the future transaction and/or the time associated with the future transaction. For example, transaction service provide system 108 may associate and/or store the amount associated with the future transaction and/or the time associated with the future transaction as account data associated with the account identifier. In some non-limiting embodiments or aspects, transaction service provider system 108 may obtain the account data from one or more databases or systems implemented within or external to transaction service provider system 108 that store account data in association with account identifiers. For example, transaction service provider system 108 may use an account identifier included in an account verification request to retrieve the account data associated with that account identifier from the one or more databases or systems, merchant system 102, payment gateway system 104, acquirer system 106, issuer system 110, user device 112, or any combination thereof.

In some non-limiting embodiments or aspects, a preferred billing date corresponds to a date at which an amount associated with a future transaction satisfies a threshold amount (e.g., a date at which an amount owed to a merchant that has been accrued by a customer associated with the account identifier satisfies a threshold amount, etc.). For example, transaction service provider system 108 may predict as a preferred billing date an amount associated with a probability of a future transaction associated with the account identifier being authorized for that amount (e.g., a preferred billing amount associated with a probability of a future transaction associated with the account identifier being authorized for that amount above a threshold probability, an optimal billing amount associated with an optimal or highest probability of a range of probabilities of approval for a range of amounts of a future transaction associated with the account identifier being authorized for that amount, etc.). As an example, a preferred billing date may correspond to a date at which the amount owed to a merchant by a customer associated with the account identifier satisfies the predicted amount. For example, a merchant that charges in incremental amounts as services or goods are consumed (e.g., an Internet Service Provider (ISP), etc.) may increment an amount owed by a customer as the services or goods are consumed while delaying billing of the customer until a date on which the amount owed satisfies the predicted amount, and which date is thus the preferred billing date.

In some non-limiting embodiments or aspects, transaction service provider system 108 generates the probability score including the probability of the future transaction associated with the account identifier being authorized based on a machine learning technique (e.g., a pattern recognition technique, a data mining technique, a heuristic technique, a supervised learning technique, an unsupervised learning technique, etc.). For example, transaction service provider system 108 generates a neural network model (e.g., an estimator, a classifier, a prediction model, etc.) based on a machine learning algorithm (e.g., a Gaussian algorithm, a non-Gaussian algorithm, a chi-squared algorithm, a decision tree algorithm, a gradient boosted decision tree algorithm, a random forest algorithm, a neural network algorithm, a convolutional neural network algorithm, etc.). In such an example, transaction service provider system 108 generates the prediction score using the neural network model.

In some non-limiting embodiments or aspects, transaction service provider system 108 generates the neural network model based on account data associated with the account identifier to optimize an objective function. For example, the neural network model may be designed to receive, as an input, the account data, and provide, as an output, a prediction (e.g., a probability, a binary output, a yes-no output, a score, a prediction score, etc.) as to the probability of the future transaction associated with the account identifier being authorized.

In some non-limiting embodiments or aspects, transaction service provider system 108 processes the account data to obtain training data for the model. For example, transaction service provider system 108 processes the account data to change the account data into a format that is analyzed (e.g., by transaction service provider system 108) to generate the model. The account data that is changed is referred to as training data. In some implementations, transaction service provider system 108 processes the account data to obtain the training data based on receiving the account verification response. Additionally, or alternatively, transaction service provider system 108 processes the account data to obtain the training data based on transaction service provider system 108 receiving an indication that transaction service provider system 108 is to process the account data from a user of transaction service provider system 108, such as when transaction service provider system 108 receives an indication to create a model for predicting whether future transactions are likely to be approved for a verified account identifier and/or payment device.

In some non-limiting embodiments or aspects, transaction service provider system 108 processes the account data by determining one or more variables based on the account data. In some non-limiting embodiments or aspects, a variable includes a metric, which is derived based on the account data. The variable is analyzed to generate a model. For example, the variable includes a variable associated with one or more parameters associated with an account identifier, such as a type of a payment device associated with the account identifier, a reloadability associated with the payment device, a transaction history associated with the account identifier, an amount of recurring billing associated with the account identifier, an approval rate associated with the account identifier, an amount of time associated with the account identifier being active, an expiration date of the payment device, an amount associated with the future transaction and a time associated with the future transaction or any combination thereof.

In some non-limiting embodiments or aspects, transaction service provider system 108 analyzes the training data to generate a neural network model (e.g., a classifier model, a prediction model, etc.). For example, transaction service provider system 108 uses machine learning techniques to analyze the training data to generate the neural network model. As an example, generating the neural network model (e.g., based on training data, etc.) is referred to as training the neural network model. In such an example, machine learning techniques may include supervised and/or unsupervised techniques, such as decision trees (e.g., gradient boosted decision trees), random forest algorithms, logistic regressions, artificial neural networks (e.g., convolutional neural networks, etc.), Bayesian statistics, Gaussian distributions, non-Gaussian distributions, chi-squared distributions, learning automata, Hidden Markov Modeling, linear classifiers, quadratic classifiers, association rule learning, and/or the like. In some non-limiting embodiments or aspects, the neural network model includes a classifier model that is specific to a particular requesting system (e.g., a particular merchant system 102, etc.) and/or the like.

Additionally, or alternatively, when analyzing the training data, transaction service provider system 108 identifies one or more variables (e.g., one or more independent variables) as predictor variables that are used to make a prediction (e.g., when analyzing the training data). In some implementations, values of the predictor variables are inputs to the model. For example, transaction service provider system 108 identifies a subset (e.g., a proper subset) of variables as predictor variables that are used to accurately predict the probability of the future transaction associated with the account identifier being authorized. In some implementations, the predictor variables include one or more of the variables, as discussed above, that have a significant impact (e.g., an impact satisfying a threshold) on a probability that the future transaction associated with the account identifier is authorized.

In some non-limiting embodiments or aspects, transaction service provider system 108 validates the neural network model by providing validation data associated with previously processed future transactions for account identifiers, and determining, based on an output of the neural network model, whether the neural network model correctly, or incorrectly, predicted the probability of the future transactions associated with the account identifiers being authorized. For example, transaction service provider system 108 may validate the neural network model based on a validation threshold (e.g., a threshold value of the validation data, etc.). As an example, transaction service provider system 108 may be programmed and/or configured to validate the model when the authorization of the future transactions associated with the account identifiers is correctly predicted by the model (e.g., when the prediction model correctly predicts 50% of the validation data, when the prediction model correctly predicts 70% of the validation data, etc.).

In some non-limiting embodiments or aspects, after the neural network model has been validated, transaction service provider system 108 may further train and/or update the neural network model and/or create new models based on receiving new training data. In some non-limiting embodiments or aspects, the new training data includes account data associated with one or more new and/or current account identifiers and/or one or more subsequent future transactions to the one or more new and/or current account identifiers that is different from the plurality of previously processed account identifiers.

In some non-limiting embodiments or aspects, after the neural network model has been trained and/or validated, transaction service provider system 108 provides a trained neural network. For example, transaction service provider system 108 may store the trained neural network model (e.g., store the neural network model for later use, etc.). In some non-limiting embodiments or aspects, transaction service provider system 108 stores the trained neural network model in a data structure (e.g., a database, a linked list, a tree, etc.). In some non-limiting embodiments or aspects, the data structure is located within transaction service provider system 108 and/or external (e.g., remote from) transaction service provider system 108. In some non-limiting embodiments or aspects, transaction service provider system 108 provides the trained neural network model to another system or device of transaction processing network 101, such as issuer system 110, merchant system 102, and/or the like.

In some non-limiting embodiments or aspects, transaction service provider system 108 compares a prediction score associated with an account identifier to a threshold value of a prediction score. In some non-limiting embodiments, transaction service provider system 108 determines the likelihood of future approval of a transaction associated with the account identifier as a score that may range from a lower confidence of future approval to a higher confidence of future approval. For example, transaction service provider system 108 may determine the prediction score as a two digit score ranging from a lower confidence of future approval (e.g., 00, etc.) to a higher confidence of future approval (e.g., 99, etc.).

In some non-limiting embodiments or aspects, transaction service provider system 108 generates the preferred billing date(s) based on a machine learning technique (e.g., a pattern recognition technique, a data mining technique, a heuristic technique, a supervised learning technique, an unsupervised learning technique, etc.). For example, transaction service provider system 108 generates a neural network model (e.g., an estimator, a classifier, a prediction model, etc.) based on a machine learning algorithm (e.g., a Gaussian algorithm, a non-Gaussian algorithm, a chi-squared algorithm, a decision tree algorithm, a gradient boosted decision tree algorithm, a random forest algorithm, a neural network algorithm, a convolutional neural network algorithm, etc.). In such an example, transaction service provider system 108 generates the preferred billing date(s) using the neural network model.

In some non-limiting embodiments or aspects, transaction service provider system 108 generates the neural network model for generating the preferred billing date(s) in the same or similar manner as the neural network model for generating the probability score (e.g., as described herein). In some non-limiting embodiments or aspects, the neural network model for generating the preferred billing date(s) is different from the neural network model for generating the probability score. For example, a machine learning algorithm used to generate the neural network model for generating the preferred billing date(s), an input provided to the neural network model for generating the preferred billing date(s), and/or an output provided by the neural network model for generating the preferred billing date(s) may be different than a machine learning algorithm used to generate the neural network model for generating the probability score, an input provided to the neural network model for generating the probability score, and/or an output provided by the neural network model for generating the probability score. In some non-limiting embodiments or aspects, the neural network model for generating the preferred billing date(s) and the neural network model for generating the probability score receive a same input or date feed, the neural network model for generating the preferred billing date(s) generates an output including the preferred billing date(s) based on the data feed, and the neural network model for generating the probability score generates a different output including the probability score.

As shown in FIG. 3, at step 316, process 300 includes communicating an account verification response and a probability score and/or a preferred billing date to a requesting system. For example, transaction service provider system 108 communicates an account verification response and a probability score and/or a preferred billing date to a requesting system. As an example, transaction service provider system 108 communicates the account verification response and the probability score and/or the preferred billing date(s) to the requesting system (e.g., to merchant system 102, payment gateway system 104, acquirer system 106, an ecommerce service provider, etc.).

In some non-limiting embodiments or aspects, transaction service provider system 108 may modify an account verification response to include a code or other indicator associated with the probability score and/or the preferred billing date(s). For example, the probability score and/or the preferred billing date(s) may be inserted within an existing packet of the account verification response, included in an additional header of the account verification response, appended to an end of the account verification response, and/or the like.

As shown in FIG. 3, at step 318, process 300 includes adjusting an offer based on a probability score and/or a preferred billing date(s). For example, the requesting system (e.g., merchant system 102, payment gateway system 104, acquirer system 106, an ecommerce service provider, etc.) may adjust an offer based on a probability score and/or a preferred billing date(s). As an example, merchant system 102 may receive the account verification response indicating that the account identifier associated therewith is approved and the probability score including the probability of the future transaction associated with the account identifier being authorized and/or the preferred billing date(s) associated with a higher or highest probability of the future transaction associated with the account identifier being authorized. In such an example, based on the probability score and/or the preferred billing date(s), merchant system 102 may adjust a promotional offer (e.g., offer terms, offer length, payment amount, payment date, etc.) to a consumer associated with the account identifier and/or request or require a different account identifier and/or payment device be used in order for the consumer to receive the promotional offer. For example, merchant system 102 may compare the probability score and/or preferred billing date(s) to one or more thresholds to determine the offer terms, a future billing date, and/or whether to seek alternative payment from the consumer. As an example, a higher probability score may be associated with a higher likelihood of a future transaction being declined (or vice-versa), which may cause merchant system 102 to decrease a time period for the promotional offer, request an alternative payment device be used to enroll in the promotional offer, and/or the like. As an example, an optimal billing date may cause a merchant system 102 to adjust a future billing date or transaction authorization request for the promotional offer to be on the optimal billing date.

In some non-limiting embodiments or aspects, the requesting system (e.g., merchant system 102, payment gateway system 104, acquirer system 106, an ecommerce service provider, etc.) may determine, based on a probability score and/or a preferred billing date(s), a retry date for one or more retry attempts to approve a previously declined transaction and/or to forgo one or more retry attempts to approve a previously declined transaction. For example, an account identifier associated with a probability score that fails to satisfy a threshold probability (e.g., a payment device with a very low score that has a very low likelihood of approval, etc.) may not be a good candidate for repeated retry attempts at approval. As an example, merchant system 102 may communicate directly with the customer associated with the account identifier instead of attempting repeated retry attempts. In contrast, many merchant systems typically use a uniform (and often blunt) retry strategy for cards resulting in excessive declines on a subset of cards which negatively impacts an overall approval rate for the merchant system and/or results in higher processing costs for the merchant system. Merchant system 102 may use the preferred billing date(s) described herein to time or schedule authorization retries following a declined transaction to improve a probability of the retries being approved, which may result in a better overall approval rate for the merchant and/or lower processing costs for the merchant. For example, merchant system 102 may send another account verification request after a transaction is declined to get an updated retry date/optimal billing date.

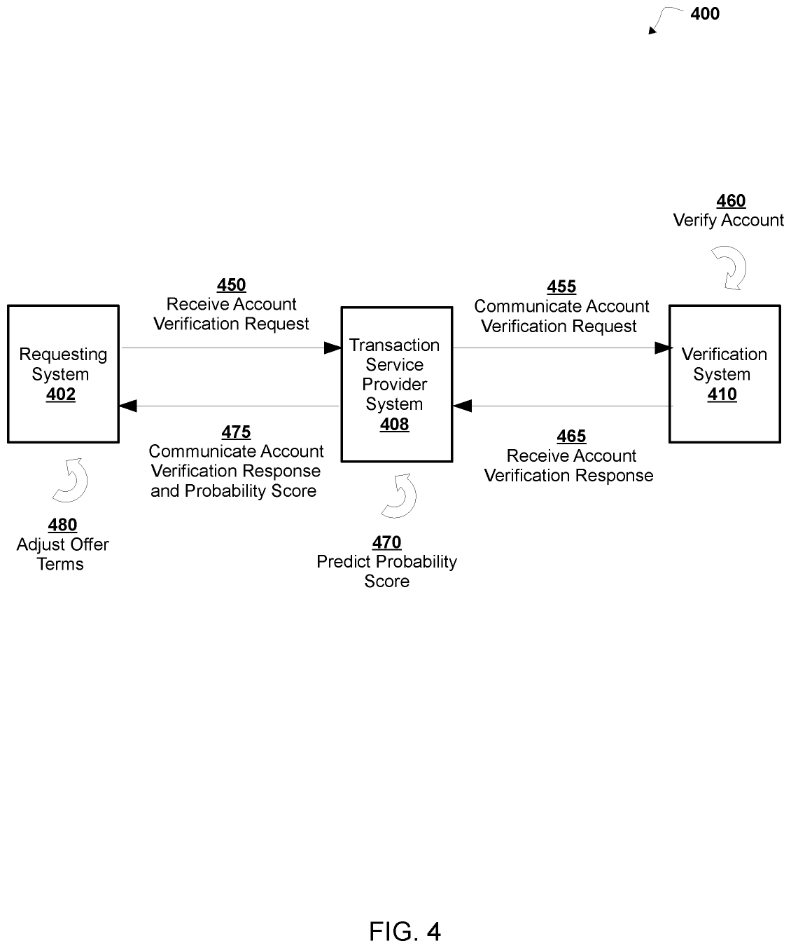

Referring now to FIG. 4, FIG. 4 is a signal flow diagram of an implementation 400 of non-limiting embodiments or aspects relating to a process for account verification. As shown in FIG. 4, implementation 400 includes requesting system 402, transaction service provider system 408, verification system 410, and/or the like. In some non-limiting embodiments or aspects, requesting system 402 can be the same or similar to at least one of merchant system 102, payment gateway system 104, acquirer system 106, or any combination thereof. In some non-limiting embodiments or aspects, transaction service provider system 408 can be the same or similar to transaction service provider system 108. In some non-limiting embodiments or aspects, verification system 410 can be the same or similar to issuer system 110.

As shown by reference number 450 in FIG. 4, transaction service provider system 408 receives an account verification request from requesting system 402.

As shown by reference number 455 in FIG. 4, transaction service provider system 408 communicates the account verification request to verification system 410.

As shown by reference number 460 in FIG. 4, verification system 410 verifies the account identifier associated with the account verification request.

As shown by reference number 465 in FIG. 4, transaction service provider system 408 receives an account verification response from verification system 410.

As shown by reference number 470 in FIG. 4, transaction service provider system 408 predicts, based on account data associated with an account identifier included in the account verification request corresponding to the account verification response, a probability score including a probability of a future transaction associated with the account identifier being authorized and/or a preferred billing date(s) associated with a probability of a future transaction associated with the account identifier being authorized on that preferred billing date.

As shown by reference number 475 in FIG. 4, transaction service provider system 408 communicates the account verification response and the probability score and/or the preferred billing date(s) to requesting system 402.

As shown by reference number 480 in FIG. 4, requesting system 402 adjusts offer terms associated with a promotional offer to a consumer based on the probability score and/or the preferred billing date(s).

Although embodiments or aspects have been described in detail for the purpose of illustration and description, it is to be understood that such detail is solely for that purpose and that embodiments or aspects are not limited to the disclosed embodiments or aspects, but, on the contrary, are intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method comprising:
receiving, with at least one processor from a verification system, an account verification response corresponding to an account verification request, wherein the account verification request is associated with an account identifier, and wherein the account identifier is associated with account data;
predicting, with at least one processor, based on the account data, at least one of: (i) a probability score including a probability of a future transaction associated with the account identifier being authorized and (ii) a preferred billing date associated with a probability of the future transaction associated with the account identifier being authorized on that preferred billing date; and
communicating, with at least one processor to a requesting system, the account verification response and the at least one of: (i) the probability score and (ii) the preferred billing date.

2. The computer-implemented method of claim 1, further comprising:
receiving, with at least one processor from the requesting system, the account verification request; and
communicating, with at least one processor to the verification system, the account verification request.

3. The computer-implemented method of claim 2, further comprising:
receiving, with at least one processor from the requesting system, an amount associated with the future transaction and a time associated with the future transaction, wherein predicting the at least one of: (i) the probability score and (ii) the preferred billing date is further based on the amount associated with the future transaction and the time associated with the future transaction.

4. The computer-implemented method of claim 1, wherein the account data is associated with at least one of: a type of a payment device associated with the account identifier, a reloadability associated with the payment device, a transaction history associated with the account identifier, an amount of recurring billing associated with the account identifier, an approval rate associated with the account identifier, an amount of time associated with the account identifier being active, an expiration date of the payment device, or any combination thereof.

5. The computer-implemented method of claim 1, wherein the account verification request does not include a transaction amount.

6. The computer-implemented method of claim 1, wherein the future transaction includes a recurring transaction.

7. The computer-implemented method of claim 1, wherein the verification system includes an issuer system, and wherein the requesting system includes at least one of a merchant system and an acquirer system.

8. A computing system comprising:
one or more processors programmed and/or configured to:
receive, from a verification system, an account verification response corresponding to an account verification request, wherein the account verification request is associated with an account identifier, and wherein the account identifier is associated with account data;
predict, based on the account data, at least one of: (i) a probability score including a probability of a future transaction associated with the account identifier being authorized and (ii) a preferred billing date associated with a probability of the future transaction associated with the account identifier being authorized on that preferred billing date; and
communicate, to a requesting system, the account verification response and the at least one of: (i) the probability score and (ii) the preferred billing date.

9. The computing system of claim 8, wherein the one or more processors are further programmed and/or configured to:
receive, from the requesting system, the account verification request; and
communicate, to the verification system, the account verification request.

10. The computing system of claim 9, wherein the one or more processors are further programmed and/or configured to:
receive, from the requesting system, an amount associated with the future transaction and a time associated with the future transaction, wherein the at least one of: (i) the probability score and (ii) the preferred billing date is further predicted based on the amount associated with the future transaction and the time associated with the future transaction.

11. The computing system of claim 8, wherein the account data is associated with at least one of: a type of a payment device associated with the account identifier, a reloadability associated with the payment device, a transaction history associated with the account identifier, an amount of recurring billing associated with the account identifier, an approval rate associated with the account identifier, an amount of time associated with the account identifier being active, an expiration date of the payment device, or any combination thereof.

12. The computing system of claim 8, wherein the account verification request does not include a transaction amount.

13. The computing system of claim 8, wherein the future transaction includes a recurring transaction.

14. The computing system of claim 8, wherein the verification system includes an issuer system, and wherein the requesting system includes at least one of a merchant system and an acquirer system.

15. A computer program product comprising at least one non-transitory computer-readable medium including program instructions that, when executed by at least one processor, cause the at least one processor to:
receive, from a verification system, an account verification response corresponding to an account verification request, wherein the account verification request is associated with an account identifier, and wherein the account identifier is associated with account data;
predict, based on the account data, at least one of: (i) a probability score including a probability of a future transaction associated with the account identifier being authorized and (ii) a preferred billing date associated with a probability of the future transaction associated with the account identifier being authorized on that preferred billing date; and
communicate, to a requesting system, the account verification response and the at least one of: (i) the probability score and (ii) the preferred billing date.

16. The computer program product of claim 15, wherein the instructions further cause the at least one processor to:
receive, from the requesting system, the account verification request; and
communicate, to the verification system, the account verification request.

17. The computer program product of claim 16, wherein the instructions further cause the at least one processor to:
receive, from the requesting system, an amount associated with the future transaction and a time associated with the future transaction, wherein the at least one of: (i) the probability score and (ii) the preferred billing date is further predicted based on the amount associated with the future transaction and the time associated with the future transaction.

18. The computer program product of claim 15, wherein the account data is associated with at least one of: a type of a payment device associated with the account identifier, a reloadability associated with the payment device, a transaction history associated with the account identifier, an amount of recurring billing associated with the account identifier, an approval rate associated with the account identifier, an amount of time associated with the account identifier being active, an expiration date of the payment device, or any combination thereof.

19. The computer program product of claim 15, wherein the account verification request does not include a transaction amount, and wherein the future transaction includes a recurring transaction.

20. The computer program product of claim 15, wherein the verification system includes an issuer system, and wherein the requesting system includes at least one of a merchant system and an acquirer system.
